(19) United States
(12) Patent Application Publication
(10) Pub. No.: US 2024/0129558 A1
(43) Pub. Date: Apr. 18, 2024

(54) SYSTEMS AND METHODS FOR LIVE AND PRE-RECORDING BROADCASTING

(71) Applicant: VUERZ, LLC, ACWORTH, GA (US)

(72) Inventor: ROLANDO NOOKS, ACWORTH, GA (US)

(73) Assignee: VUERZ, LLC, ACWORTH, GA (US)

(21) Appl. No.: 18/467,702

(22) Filed: Sep. 14, 2023

Related U.S. Application Data
(60) Provisional application No. 63/375,688, filed on Sep. 14, 2022.
(60) Provisional application No. 63/488,762, filed on Mar. 6, 2023.

(51) Int. Cl. H04N 21/2187; H04N 21/238; H04N 21/845

(52) U.S. Cl. CPC H04N 21/2187; H04N 21/238; H04N 21/8456

(57) ABSTRACT

Systems and methods are disclosed for live and pre-recording broadcasting. An example method may include capturing, in real time, video images of a funeral service at a location; transmitting, via at least one network, one or more of the video images to at least one RTMP (real time messaging protocol) server; and facilitating end user access at a remote location comprising a correctional facility, via the at least one RTMP server, to the one or more video images, wherein the end user access comprises playback of the one or more video images on a media playing application or apparatus.

### RELATED APPLICATIONS

The present application claims priority to U.S. Provisional Ser. No. 63/375,688, titled “Compassionate Reprieve Virtual capture distribution and method”, filed Sep. 14, 2022; U.S. Non-Provisional Ser. No. 18/062,558, titled “VUERZ”, filed Dec. 6, 2022; and to U.S. Provisional Ser. No. 63/488,762, titled “Live and pre-recording broadcasting process method with HLS Offline”, filed Mar. 6, 2023, which are all incorporated herein by reference.

### FIELD OF DISCLOSURE

The present disclosure relates to secure video transmission, and more particularly to systems and methods for live and pre-recording broadcasting.

### BACKGROUND

According to the United States Sentencing Commission March 2022 report, approximately 47.9% of persons incarcerated who applied for compassionate reprieve were denied. The count in 18 U.S.C. § 3553(a) cited the nature of the offense factors or these persons were deemed a danger to the public. This means about half of the incarcerated population has been denied the fundamental component of cultural and religious mourning practice. Persons who are incarcerated are not allowed to pay their last respects to their family members who have passed away. Any death is tragic and is compounded when one is not able to pay her or her final respects. While persons who are incarcerated have broken the law, these persons are still human beings and helping them, to maintain a connection to the community, in which most of them will someday return to, is a relatively important step to long-term public safety. In the United States, millions of incarcerated individuals are housed in designated controlled facilities all over the country. The rights of these incarcerated individuals are largely affected due to various reasons such as their offense, safety to themselves, safety to public, safety to officers and to other offenders. However, individuals that are incarcerated are still entitled to a few privileges that vary depending on the nature of their crimes.

### BRIEF SUMMARY OF THE DISCLOSURE

Embodiments of the disclosure can relate to systems and methods for live and pre-recording broadcasting. Further, embodiments of the disclosure can relate to systems and methods for providing compassionate reprieve virtual funeral services.

Embodiments of the disclosure can provide systems and methods for receiving and processing video and audio signals captured during a funeral service at a location, such as a funeral home, and streaming and storing the video and audio signals via a RTMP (real time messaging protocol) server. The RTMP server can further securely stream video and audio to a media playing application or apparatus at a remote location, such as a correctional facility, wherein the video and audio signals captured during the funeral service can be downloaded and played by an end user.

In one embodiment of the disclosure, a method can include capturing, in real time, video images of a funeral service at a location; transmitting, via at least one network, one or more of the video images to at least one RTMP (real time messaging protocol) server; and facilitating end user access at a remote location comprising a correctional facility, via the at least one RTMP server, to the one or more video images, wherein the end user access comprises playback of the one or more video images on a media playing application or apparatus.

In one aspect of the embodiment, the transmitting one or more video images is facilitated by a HLS (HTTP live streaming) protocol.

In one aspect of the embodiment, the playback on a media playing application or apparatus further comprises playback of a downloaded file from the at least one RTMP server to the media playing application or apparatus.

In one aspect of the embodiment, the downloaded file is stored locally on the media playing apparatus, wherein the one or more video images are stored in chunks or segments.

In one aspect of the embodiment, the media playing application or apparatus is operable to facilitate playback of the one or more video images without network connectivity for the media playing application or apparatus during the playback.

In one aspect of the embodiment, the method further includes synchronizing playback of the one or more video images with audio captured, in real time, at the funeral service at the location.

In one aspect of the embodiment, the at least one RTMP (real time messaging protocol) server generates a unique and secure link via the at least one network for transmitting the one or more video images to at least one communication device associated with an end user at the remote location.

In one aspect of the embodiment, the method further includes authenticating, based at least in part on receiving the unique and secure link from the location; encoding the video images from the location; and generating, via the at least one RTMP (real time messaging protocol) server, a destination URL (uniform resource locator) for facilitating end user access at the remote location, via the at least one RTMP server, to the one or more encoded video images.

In one aspect of the embodiment, the method further includes prior to facilitating end user access at a remote location, evaluating the one or more video images by reviewing the one or more video images at the at least one RTMP (real time messaging protocol) server.

In one embodiment of the disclosure, a system can include a processor; and a memory storing computer-executable instructions, that when executed by the processor, cause the processor to: capture, in real time, video images of a funeral service at a location; transmit, via at least one network, one or more of the video images to at least one RTMP (real time messaging protocol) server; and facilitate end user access at a remote location comprising a correctional facility, via the at least one RTMP server, to the one or more video images, wherein the end user access comprises playback of the one or more video images on a media playing application or apparatus.

In one aspect of the embodiment, the computer-executable instructions operable to transmit one or more video images are facilitated by a HLS (HTTP live streaming) protocol.

In one aspect of the embodiment, the playback on a media playing application or apparatus further includes playback of a downloaded file from the at least one RTMP server to the media playing application or apparatus.

In one aspect of the embodiment, the downloaded file is stored locally on the media playing apparatus, wherein the one or more video images are stored in chunks or segments.

In one aspect of the embodiment, the media playing application or apparatus is operable to facilitate playback of the one or more video images without network connectivity for the media playing application or apparatus during the playback.

In one aspect of the embodiment, the computer-executable instructions, when executed by the processor, further cause the processor to synchronize playback of the one or more video images with audio captured, in real time, at the funeral service at the location.

In one aspect of the embodiment, the at least one RTMP (real time messaging protocol) server generates a unique and secure link via the at least one network for transmitting the one or more video images to at least one communication device associated with an end user at the remote location.

In one aspect of the embodiment, the system further includes computer-executable instructions, that when executed by the processor, cause the processor to: authenticate, based at least in part on receiving the unique and secure link from the location; encode the video images from the location; and generate, via the at least one RTMP (real time messaging protocol) server, a destination URL (uniform resource locator) for facilitating end user access at the remote location, via the at least one RTMP server, to the one or more encoded video images.

In one aspect of the embodiment, the system further includes computer-executable instructions, that when executed by the processor, cause the processor to: prior to facilitating end user access at a remote location, evaluate the one or more video images by reviewing the one or more video images at the at least one RTMP (real time messaging protocol) server.

In one embodiment, a non-transitory computer-readable medium can be provided for storing computer-executable instructions, that when executed by a processor, cause the processor to perform operations of: capturing, in real time, video images of a funeral service at a location; authenticating, based at least in part on receiving the unique and secure link from the location; encoding the video images from the location; generating, via the at least one RTMP (real time messaging protocol) server, a destination URL (uniform resource locator) for facilitating end user access at the remote location, via the at least one RTMP server, to the one or more encoded video images; transmitting, via at least one network, one or more of the video images to at least one RTMP (real time messaging protocol) server; and facilitating end user access at a remote location comprising a correctional facility, via the at least one RTMP server, to the one or more video images, wherein the end user access comprises playback of the one or more video images on a media playing application or apparatus.

In one aspect of the embodiment, the non-transitory computer-readable medium can further include computer-executable instructions, that when executed by the processor, cause the processor to: prior to facilitating end user access at a remote location, evaluating the one or more video images by reviewing the one or more video images at the at least one RTMP (real time messaging protocol) server.

### BRIEF DESCRIPTION OF THE DRAWINGS

FIG. 1 depicts a schematic diagram of an example system, in accordance with one or more example embodiments of the disclosure.

FIG. 2 depicts a schematic diagram of another example system, in accordance with one or more example embodiments of the disclosure.

FIG. 3 depicts a schematic diagram of yet another example system, in accordance with one or more example embodiments of the disclosure.

FIG. 4 depicts a schematic diagram of yet another example system, in accordance with one or more example embodiments of the disclosure.

FIG. 5 depicts a schematic diagram of yet another example system in accordance with one or more example embodiments of the disclosure.

FIG. 6 depicts a schematic diagram of yet another example system, in accordance with one or more example embodiments of the disclosure.

FIG. 7 depicts a schematic diagram of yet another example system, in accordance with one or more example embodiments of the disclosure.

FIG. 8 depicts a schematic diagram of yet another example system, in accordance with one or more example embodiments of the disclosure.

FIG. 9 depicts a schematic diagram of yet another example system, in accordance with one or more example embodiments of the disclosure.

FIG. 10 depicts a schematic diagram of yet another example system, in accordance with one or more example embodiments of the disclosure.

FIG. 11 is a block diagram of an example method, in accordance with one or more example embodiments of the disclosure.

FIG. 12 is a block diagram of another example method, in accordance with one or more example embodiments of the disclosure.

The following detailed description is set forth with reference to the accompanying drawings. The drawings are provided for purposes of illustration only and merely depict exemplary embodiments of the disclosure. The drawings are provided to facilitate understanding of the disclosure and shall not be deemed to limit the breadth, scope, or applicability of the disclosure. In the drawings, the left-most digit(s) of a reference numeral may identify the drawing in which the reference numeral first appears. The use of the same reference numerals indicates similar, but not necessarily the same or identical components. However, different reference numerals may be used to identify similar components as well.

Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

### Overview

This disclosure relates to, among other things, systems and methods for live and pre-recording broadcasting.

In certain embodiments, the disclosure relates to systems and methods for providing compassionate reprieve virtual funeral services. For example, certain embodiments can facilitate sending and receiving live audio and video, such as a live stream video or pre-recorded video, of a funeral service to and from a jail, prison and/or correctional facility via at least one communication device.

In certain embodiments, the disclosure relates to systems and methods for live and pre-recording broadcasting, and storing audio and video of a funeral service held at a funeral home. A live broadcast of video and audio can be transmitted to a RTMP (real time messaging protocol) server, or a content delivery network (CDN), using a HTTP live streaming (HLS) protocol. The live broadcast can be accessed by an end user through playback of the audio and video, or playback of a downloaded file. In this manner, one or more end users can remotely participate in the funeral service. Moreover, the relatively efficient and reliable delivery of the live broadcast can be provided to an end user regardless of his or her location, Internet connection speed, or network connectivity status.

In certain embodiments, the disclosure provides a novel approach to address the challenge of playing back HLS content offline in mobile and web applications, enabling end users to access and consume media content even when an Internet connection is unstable or otherwise unavailable. In this manner, offline playback of HLS content can be delivered in a relatively efficient, reliable, and seamless manner, thus providing a relatively high quality end user experience.

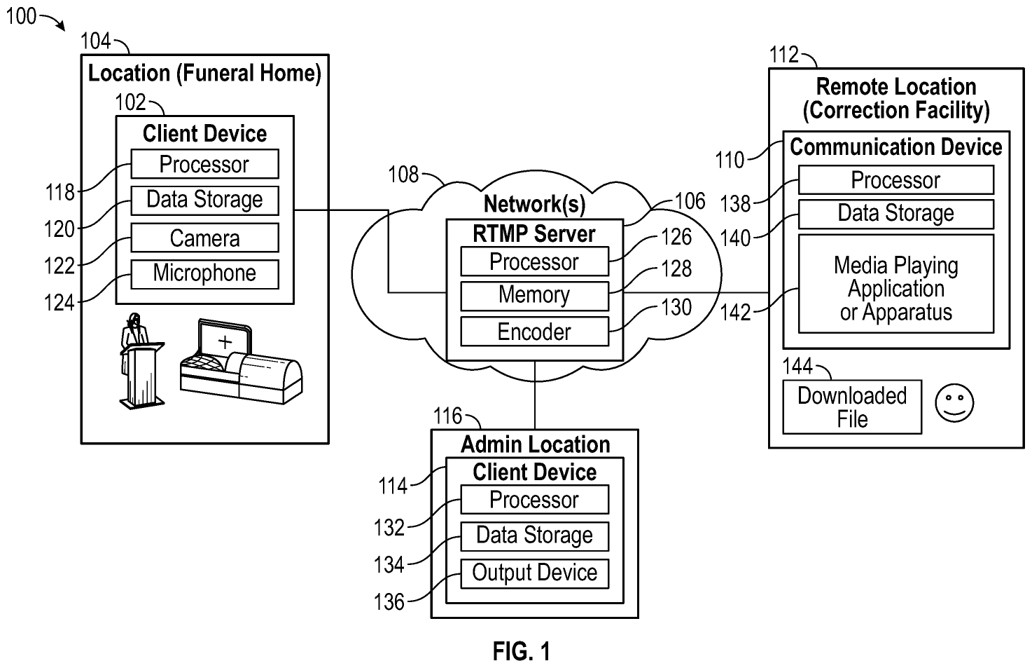

FIG. 1 depicts a schematic diagram of an example system, in accordance with one or more example embodiments of the disclosure. The system 100 can include at least one client device 102 at a location 104, such as a funeral home. The system 100 can also include a RTMP server 106 associated with at least one network 108. The system 100 can also include a communication device 110 at a remote location 112, such as a correction facility. In one embodiment, the system 100 can include another client device 114 at an admin location 116.

The client device 102 at location 104, such as a funeral home, can include a processor 118, a data storage device 120, a camera 122, and a microphone 124. The processor 118 can communicate with the data storage device 120, or the RTMP server 106, to obtain one or more computer-executable instructions. The processor 118 can also communicate with the camera 122 to receive video images and/or signals from the camera 122. Further, the processor 118 can communicate with the microphone 124 to receive audio signals from the microphone 124. In particular, the camera 122 and microphone 124 can capture, in real time, respective video images and/or signals, and audio signals from a funeral service taking place at the location 104.

In some instances, certain embodiments can include a camera that captures video in real-time.

In some instances, certain embodiments can include one or more cameras and/or mobile communication devices mounted on tripods or other stands at a location, such as a funeral home. The one or more plurality of cameras and/or mobile communication devices can have a view of desired areas of interest, and the cameras and/or mobile devices can send real-time live audio video streams of the funeral service.

In some instances, certain embodiments can include at least two microphones that can provide audio and/or audio signals to the processor of a client device, or to a RTMP server, wherein the processor or RTMP server can further synchronize the video and/or video signals into a synchronized audio and video.

In some instances, certain embodiments can include at least one mobile communication device, such as a tablet computer or mobile phone, with an extended camera lens that can provide extended video signals to the processor of a client device, or to a RTMP server, and the processor can further extend the video signals.

In some instances, certain embodiments can include at least one camera that can be mounted adjacent an area of interest in the location, for instance a funeral home, such that the at least one camera views the areas of interest and provides video and/or video signals of the funeral service. The video and/or video signals as well as associated audio and/or audio signals can be stored locally to the camera, and can be reproduced and transmitted to an end user, via the network, over a secure communication channel and/or secure online link facilitated by an application program or Internet browser application.

In some instances, certain embodiments can include a processor associated with a client device, or a RTMP server, that can access a desired combined pre-recorded file stored on an associated storage device, memory, or data storage device, and the processor can replay at least synchronized video signals from the combined pre-recorded file on an output device, or a media playing application or apparatus.

In some instances, certain embodiments can include a client device, or a RTMP server, with a transmission module operable to establish a communication connection at a transport layer level with, or for, the RTMP server.

In some instances, certain embodiments can include a client device, or a RTMP server, with WebSocket module that can establish a WebSocket connection with, or for, the RTMP server via a handshake procedure based on the communication connection.

In some instances, certain embodiments can include a client device, or a RTMP server, with a WebSocket module that transmits or receives WebSocket packets to or from, or for, the RTMP server while maintaining a relatively stable WebSocket connection.

In some instances, certain embodiments can include a client device with a streaming module that receives real-time transport protocol (RTP) packets carried by the WebSocket packets.

In the embodiment shown, the processor 118 of the client device 102 can also execute one or more computer-executable instructions stored in the data storage device 120 to instruct the camera 122 to capture, in real time, video images of a funeral service at the location 104. In some instances, the processor 118 can also execute one or more computer-executable instructions stored in the data storage device 120 to instruct the microphone 124 to capture, in real time, audio of a funeral service at the location 104 using the microphone 124.

In any instance, the processor 118 of the client device 102 can execute one or more computer-executable instructions stored in the data storage device 120 to transmit, via the network 108, one or more of the video images to the RTMP server 106.

In some instances, the transmission of one or more video images to the RTMP server 106 can be facilitated by a HLS (HTTP live streaming) protocol, or any other suitable protocol.

In some instances, the RTMP server 106 can authenticate, based at least in part on receiving a unique and secure link generated by and from the client device 102 at the location 104, such as a funeral home, the video images received from the client device 102.

The RTMP server 106 can include a processor 126, a data storage device or memory 128, and an encoder 130. The processor 126 can communicate with the data storage device or memory 128 or a client device such as 102, to obtain one or more computer-executable instructions. The RTMP server 106 can receive one or more of the video images from the client device 102 and/or camera 122, and store the video images in a data storage device or memory 128. Further, the RTMP server 106 can receive audio and/or audio signals from the client device 102 and/or microphone 124, and store the audio and/or audio signals in the data storage device or memory 128.

In some embodiments, the RTMP server can be any streaming server configured to support a third-party streaming service or platforms, including for example, but not limited to YouTube, Twitch, Facebook Live, and Vimeo,

In some instances, the RTMP server 106 can encode, via the encoder 130, the received video images from the client device 102. In some instances, the encoder can be operable to encode the video captured by the camera in a format suitable for transmission to the communication device 110, or an associated media playing application or apparatus. In some instances, certain embodiments can include a network interface operable to transmit the encoded video to the communication device 110, or an associated media playing application or apparatus via at least one network, such as 108. In some instances, the encoder can be separately positioned at the location, such as the funeral home, wherein the location is equipped with at least one camera, one microphone, and one encoder. In any instance, an encoder can be operable to simultaneously process and compress both video and audio, aiming for reduced latency and optimal transmission clarity.

In some instances, the RTMP server 106 can generate a unique and secure link via the network 108 for transmitting the video images to the communication device 110 associated with an end user at the remote location 112, such as a correctional facility. In some instances, the secure link can be adaptable for sharing on public and/or private channels for a third-party streaming service or platform.

In some instances, one or more computer-executable instructions stored in a data storage device or memory 128 of the RTMP server 106 can be executed by the processor 126 to synchronize playback of the video images with audio captured, in real time, from the funeral service at the location 104, such as a funeral home.

In some instances, certain embodiments can include a RTMP server with a video processor that can add a graphic element viewable on an output device with the synchronized video signals.

In some instances, certain embodiments can include a RTMP server operable to facilitate a two-way conference call, or direct communication link, between an end user operating a communication device at a remote location, such as a correction facility, and an attendee of the funeral service operating a client device at the location, such as the funeral home. In this manner, an end user, such as an inmate, can participate via video in the funeral service with the attendee of the funeral service.

In some instances, certain embodiments can include a media decoder that includes a video decoder and an audio decoder that are implemented using JavaScript. Additionally, the video renderer can be configured to be implemented using JavaScript and can support the HTML5 standard.

In some instances, certain embodiments can include a media decoder that includes an audio encoder that is designed to encode audio captured by a media playing application or apparatus. This encoding can enable two-way audio communication for a two-way conference call, or direct communication link, between the media playing application or apparatus and the RTMP server.

In some instances, certain embodiments can include a media decoder that decodes a video and/or audio stream obtained from the RTP packets to reconstruct video.

In some instances, certain embodiments of the system can include an output device that can display the reconstructed video on a screen by embedding the reconstructed video in an Internet browser application.

In some instances, certain embodiments can include a WebSocket module programmed to respond to a real time streaming protocol (RTSP) command from a streaming module by transmitting a description command to the RTMP server.

In some instances, certain embodiments can include a WebSocket module that can transmit a setup command to the RTMP server in response to receiving a subsequent RTSP command.

In some instances, certain embodiments can include WebSocket packets that include a WebSocket header, an RTP header that follows the WebSocket header, and the video and/or audio stream that follows the RTP header.

In some instances, certain embodiments can include a streaming module that is configured to receive real-time transport protocol (RTP) packets carried by the WebSocket packets. In addition, the streaming module can be further programmed to transmit or receive real-time streaming protocol (RTSP) packets for controlling the transmission of the RTP packets to or from the RTMP server.

In some instances, certain embodiments of systems and methods can include a streaming module operable to generate and transmit real-time transport protocol (RTP) packets containing the encoded video to the communication device, or to an associated media playing application or apparatus.

In some instances, certain embodiments can include a control module operable to manage operation of the RTMP server and ensure that the video is transmitted reliably and efficiently to the media playing application or apparatus.

In some instances, certain embodiments can include a RTMP server, wherein the RTMP server is configured to support the HTML5 standard.

In some instances, certain embodiments can include a RTMP server that includes a proxy socket that encodes communication data into WebSocket packets for transmission to the communication device, or to the media playing application or apparatus. The proxy socket can also decode WebSocket packets received from the media playing application or apparatus in a data format supported by the RTMP server. This can contribute to the efficient and effective communication between the RTMP server and the media playing application or apparatus.

a proxy socket that encodes and decodes communication data transmitted between the media server and the media stream playing apparatus. Furthermore, the proxy socket can be operable to relay data transmission and reception by the RTMP server through a predetermined socket. This enables efficient communication by the RTMP server, contributing to the overall effectiveness of the RTMP server in transmitting high-quality video to the end-user.

In some instances, certain embodiments can include a RTMP server operable to store encoded video from an encoder for relatively long-term storage or temporarily stored to support streaming video via the RTMP server. This can ensure that the RTMP server is capable of both long-term storage and real-time streaming of video content, making it a relatively versatile and efficient tool for transmitting relatively high-quality video streams to the end user.

In some instances, the RTMP server can integrates directly with one or more third-party service or platform-specific APIs (application program interfaces), such as the YouTube Live Streaming API, to provide native streaming capabilities and features unique to the respective third-party service or platform.

In some instances, an administrator at an admin location 114 can operate the client device 114 to access the video images stored at the RTMP server 106. The client device 114 can include a processor 132, a data storage device 134, and an output device 136. Using the client device 114, one or more video images may be retrieved from the RTMP server 106 and/or associated data storage device such as memory 128 to permit the administrator to evaluate the video images prior to transmission of the images to the remote location 112, such as a correctional facility.

In some instances, one or more video images can be subjected to a content verification process at the client device 114 at the admin location 116 before being made accessible at the remote location 112, such as a correctional facility. Upon the availability and commencement of the video during the funeral service, the video can auto-play or can otherwise be initiated at the remote location 112, such as the correctional facility. Access to the video can be safeguarded by one or multiple security measures, which may include, but is not limited to, device authentication, password protection, token-based authentication, or biometric verification. In some instances, two-tier security can be implemented, wherein a first tier can ensure the video and audio is technically viable and the second tier can ensure any prohibited, inappropriate, or otherwise unsuitable video and/or audio can be filtered or otherwise removed. Evaluating the video and audio prior to granting access, with the evaluation conducted at the RTMP server, followed by a secondary security assessment conducted at a client device at an admin location, focusing on the identification and removal of video and/or audio deemed prohibited, inappropriate, or otherwise unsuitable for an end user, such as an inmate and/or staff within the remote location, such as a correctional facility.

In the embodiment shown, the communication device 110 can include a processor 138, data storage 140, and a media playing application or apparatus 142. The processor can execute one or more computer-executable instructions received by the processor from data storage 140, the RTMP server 106, and/or the client devices 102, 114.

In the embodiment shown, one or more computer-executable instructions stored by the client device 102 and/or RTMP server 106 can facilitate end user access at the remote location 112, such as a correctional facility, via the RTMP server 106, to the video images. End user access can include accessing the video images via the communication device 110. In some instances, end user access can also include, but is not limited to, playback of the video images on a media playing application or apparatus 142 via the communication device 110.

Suitable communication devices can include, but are not limited to, a television, tablet computer, laptop computer, camera, mobile communication device, hologram device, a virtual reality (VR) device, and an augmented reality (AR), or combination VR/AR device.

In at least one embodiment, the playback on the media playing application or apparatus 142 can include playback of a downloaded file 144 from the RTMP server 106 to the media playing application or apparatus 142. The downloaded file 144 can include one or more video images and/or audio previously captured from the funeral service at the location 104, such as a funeral home.

In some instances, the downloaded file 144 can be stored locally in data storage 140 or on the communication device 110 by the media playing application or apparatus 142, wherein one or more video images can be stored in chunks or segments.

In some instances, the media playing application or apparatus 142 can be operable to facilitate playback of video images without network connectivity for the media playing application or apparatus 142 during the playback. That is, the communication device 110 may be offline or otherwise without network connectivity while the video images are being played back by the media playing application or apparatus 142.

In some instances, the RTMP server 106 can generate a destination URL (uniform resource locator) for facilitating end user access at the remote location 112, via the communication device 110, to the encoded video images.

In some embodiments, the media playing application or apparatus 142 can be, or can include, a HTTP live streaming (HLS) playback application operable to playback video and/or audio. The HLS content can be in the format of a downloaded file, such as 144, that can access a stored library that supports HLS downloading, storing the downloaded content locally on the device, and playing it back using the media playing application or apparatus 142, which can support offline HLS playback.

In some instances, the media playing application or apparatus can be operable to provide an option to store or delete one or more of the downloaded video images after playback.

The downloaded file 144 can be stored locally on the communication device 110 in the form of chunks or segments, which may be saved to a file or data storage 140. In some instances, a playlist file, for example a file in “.m3u8” format, may also be created to point to the downloaded chunks.

In some instances, previously downloaded HLS content can be played back by a media playing application or apparatus that supports offline playback of HLS content. One skilled in the art will recognize the technical specifications for integrating suitable libraries and code for downloading and storing the HLS content, as well as for providing a suitable user interface for facilitating the user experience in downloading and playing back the HLS content. One skilled in the art will also recognize suitable specifications for handling the various technical requirements for playing back HLS content offline, such as supporting the various codecs and encryption methods used in HLS.

In some instances, certain embodiments can include a media playing application or apparatus that can receive a media stream originated from a RTMP server and play the content in an application program or an Internet browser application.

In some instances, certain embodiments can include a media playing application or apparatus that can operate in an application program or Internet browser application that supports the HTML5 standard.

In some instances, certain embodiments can include a media playing application or apparatus that includes a video renderer that is programmed to perform video processing on the reconstructed video according to an output of the output device. This processing can occur before the reconstructed video is transmitted from the media decoder to the output device.

In some instances, certain embodiments can include a media playing application or apparatus that is further configured such that the streaming module, media decoder, and video renderer can be implemented by JavaScript without the need to install a plug-in program in the application program or Internet browser application.

In at least one embodiment, facilitating playback of HLS can include three components. First, a RTMP server, such as 106 in FIG. 1, is responsible for taking input streams of video and audio, and digitally encoding them. The RTMP server then creates multiple bitrate streams suitable for transmission and delivery to a segmenter that creates one or more segments.

Next, the RTMP server 106 can include a distribution segment that is responsible for content distribution. When a communication device, such as 110 in FIG. 1, sends a request, the request is received by the RTMP server 106, and a response is sent back by the RTMP server 106 to the communication device 110 in the form of index files. The communication device 110 can include a media playing application or apparatus, such as 142, that can read the index files, and again request the content from the RTMP server 106. The content can then be sent from the RTMP server 106 to the communication device 110 in the form of chunks or segments. All the requests and responses can be performed through the RTMP server over HTTP. Once the content is served to the communication device 110, a cached copy of that content can be created and stored on the RTMP server.

Next, the media playing application or apparatus, such as 142, can be a computing player that can playback a HLS stream in a native application or on an HLS supported browser. Any computing player which supports HLS stream can be embedded into the application for live and on demand playback.

In some instances, certain embodiments can include a RTMP server operable to control a camera at the location, such as a funeral home, that captures video in real-time during a funeral service, and provides the captured video to the media playing application or apparatus, at a remote location, such as a correctional facility. The RTMP server can be designed to transmit video captured by the camera in real-time to the media playing application or apparatus. The video captured by the camera can then be served, via at least one network, from the RTMP server to the media playing application or apparatus.

In some instances, certain embodiments can include a media playing application or apparatus that includes a streaming module with several components. For example, the streaming module can be operable to form a communication session with the RTMP server to ensure reliable reception of video and audio, or associated signals, transmitted via real-time transport protocol (RTP). A communication device at the remote location can receive RTP packets and transmits or receives real-time streaming protocol (RTSP) packets for controlling the transmission of the RTP packets to or from the RTMP server. A client manager, or the RTMP server, creates or removes a client module in the communication device in response to requests from the media playing application or apparatus. A depacketization module, or the RTMP server, can store video and/or audio packets in a buffer and can assemble them to generate at least one video frame. The streaming module can have a unique design and functionality to enable the media playing application or apparatus to effectively receive and transmit video and audio, and associated signals, and reconstruct them for display on an output device associated with the communication device.

In one embodiment, live audio and video of a funeral service can be sent to be viewed over a secure channel to persons incarcerated and to persons attending funeral services. The live audio and video can be provided to end users who are incarcerated, families of persons who are incarcerated, inmate counselors, funeral homes, jails, prisons, correctional facilities, and any institution housing persons who are incarcerated and the like. For example, an audio and video stream can be sent to the inmate facility via a secure link, such as an application, sending and receiving live audio/video, sending live video, or pre-recorded funeral ceremonies to and from jails, prisons and/or correctional facilities via a compatible portable audio video electronic device. The inmate can also take part in the funeral service using video conference applications. The video of the inmate will display in the church or funeral home.

In one embodiment, a method for enabling real-time video conferencing during funeral service transmissions tailored for correctional facilities can be provided. The method can include establishing a two-way communication link between an inmate located at a correctional facility and a remote location hosting the funeral service; facilitating real-time video and audio data exchange over the communication link, enabling the inmate to not only view but also participate in the funeral service; implementing enhanced security measures on the video conferencing stream, including real-time content filtering, encryption, and data integrity checks, to ensure the safety and appropriateness of interactions between the correctional facility and the remote funeral service location; and providing a user interface within the correctional facility that allows for initiating, pausing, or terminating the video conferencing interaction, while also providing real-time feedback on the connection quality and security status.

In one embodiment, a method can include an inmate applying and getting approval for compassionate reprieve. The method can also include establishing long-term contracts with owners of funeral homes. These owners can benefit from additional revenue streams from the systems and methods described. Once the contracts are established, institutions such as jails, prisons, correctional facilities or any other institutions that house persons who have broken the law and are incarcerated for extended periods will be targeted to offer this service. In other embodiments, the services may be provided by the institutions listed above as a feature to the incarcerated and their families and loved ones.

Embodiments of the disclosure can provide a method for live broadcasting and storing audio and video of funeral services held at a funeral home or church where an inmate's family member is being held. The invention uses HTTP live streaming (HLS) protocol to transmit the live broadcast to a RTMP server, or content delivery network (CDN), for relatively efficient and reliable delivery to end users, including incarcerated individuals who cannot attend in person. The live broadcast can be accessed via playback by the RTMP server or CDN or downloadable file, providing a relatively convenient and accessible way for inmates to participate in the funeral service. Certain embodiments of the disclosure can ensure that the live broadcast is relatively accessible and reliable, allowing incarcerated individuals to participate in the grieving process and honor their loved ones.

Embodiments of the disclosure can provide systems and methods including one or multiple cameras and/or one or multiple mobile devices positioned in view of interest at a funeral proceeding. A system and method disclosed including one or multiple cameras and/or one or multiple mobile devices positioned in view of interest of an inmate. The system and method can include pre-recorded and/or real-time live capturing and synchronizing of audio and video of funeral ceremonies for distribution to jails, prisons, correctional facilities, or any other holding facility for person who are incarcerated. Certain systems and methods can include pre-recorded and/or real-time live capturing and synchronizing of audio and video of an inmate to the funeral home or church to be displayed on screen. These systems and methods provide compassionate reprieve virtual services. Inmates can utilize two-way video conferencing to be displayed at the funeral home on a screen.

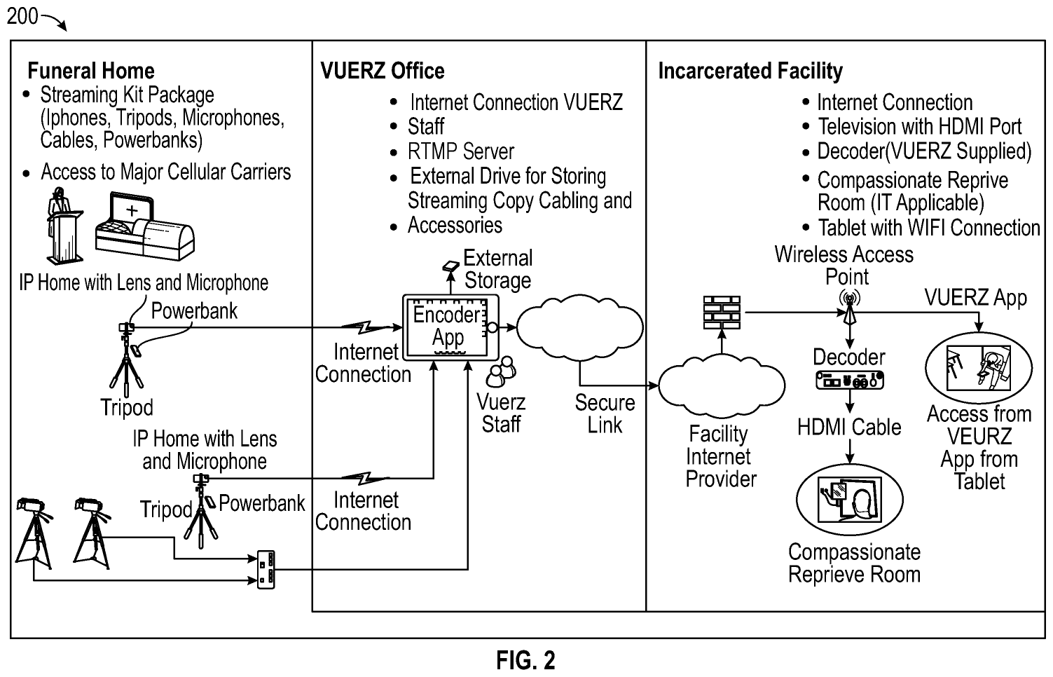

One skilled in the art will recognize that the systems and methods described in FIG. 1 can be implemented using some or all of the components described in FIG. 1. One skilled in the art will also recognize that certain embodiments of the disclosure are implemented in the system diagrams illustrated in FIGS. 2-10. These example system embodiments are intended to illustrate variations in the disclosure, and are also intended to be within the scope of one or more claims of the disclosure.

In FIG. 2, another example system 200 is depicted, in accordance with one or more example embodiments of the disclosure. The embodiment shown in FIG. 2 is similar to that shown in FIG. 1, and illustrates a system 200 utilizing an encoder or encoder application 202 at an admin location to facilitate communications between a location and a remote location.

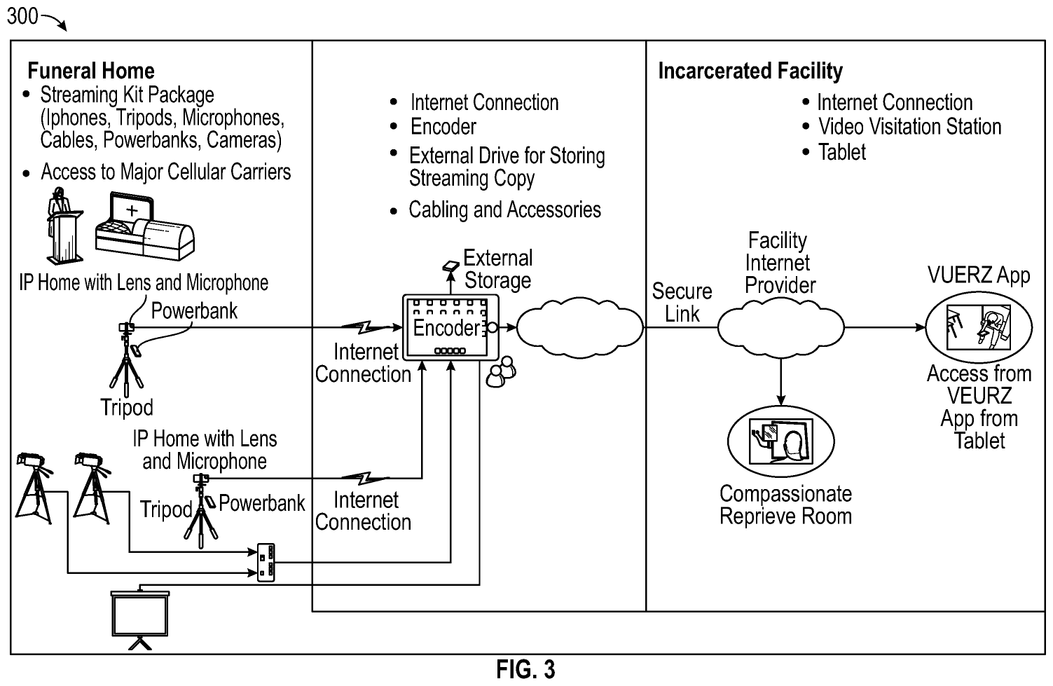

In FIG. 3, another example system 300 is depicted, in accordance with one or more example embodiments of the disclosure. The embodiment shown in FIG. 3 is similar to that shown in FIGS. 1 and 2, and illustrates a system 300 utilizing an encoder or encoder application 302 at an admin location to facilitate communications between a location and a remote location.

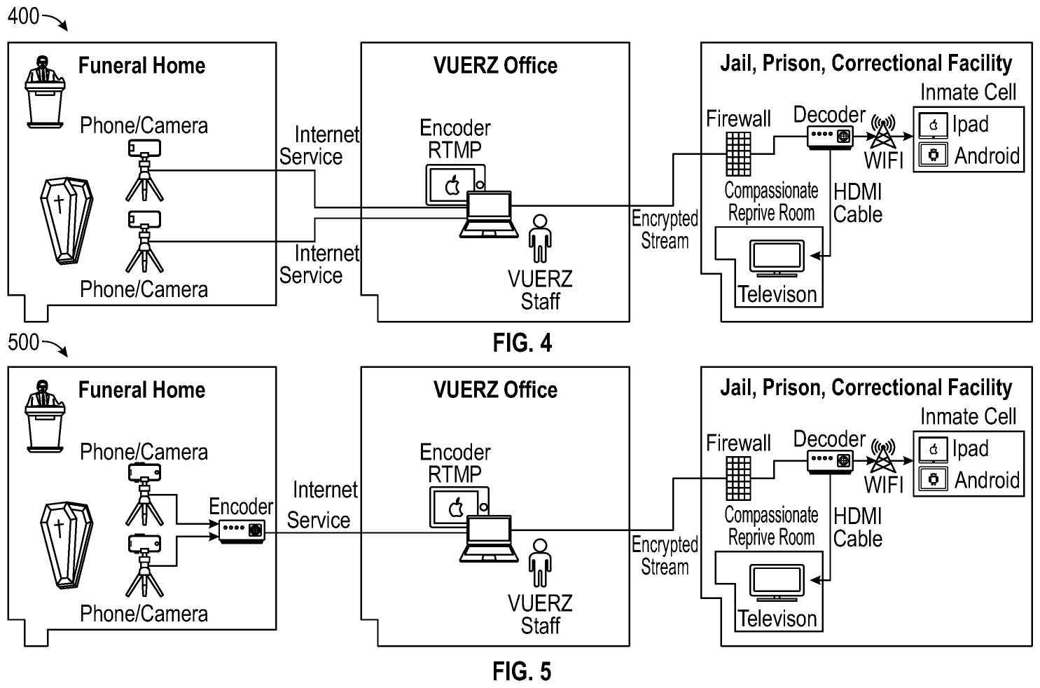

In FIG. 4, another example system 400 is depicted, in accordance with one or more example embodiments of the disclosure. The embodiment shown in FIG. 4 is similar to that shown in FIGS. 1-3, and illustrates a system 400 utilizing an encoder or encoder application 402 at an admin location to facilitate communications between a location and a remote location.

In FIG. 5, another example system 500 is depicted, in accordance with one or more example embodiments of the disclosure. The embodiment shown in FIG. 4 is similar to that shown in FIGS. 1-4, and illustrates a system 500 utilizing an encoder or encoder application 502 at an admin location to facilitate communications between a location and a remote location.

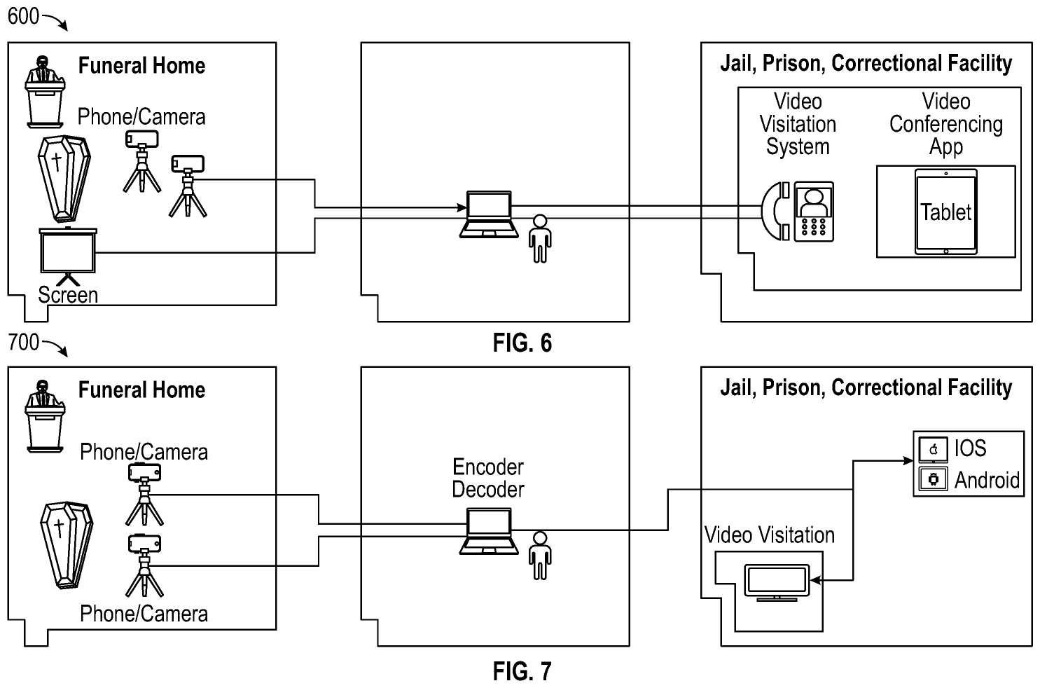

In FIG. 6, another example system 600 is depicted, in accordance with one or more example embodiments of the disclosure. The embodiment shown in FIG. 4 is similar to that shown in FIG. 1, and illustrates a system 600 utilizing a video conferencing application 602 at the remote location to facilitate communications between a location and the remote location.

In FIG. 7, another example system 600 is depicted, in accordance with one or more example embodiments of the disclosure. The embodiment shown in FIG. 7 is similar to that shown in FIG. 1, and illustrates a system 700 utilizing a communication device at the remote location to facilitate communications between a location and the remote location.

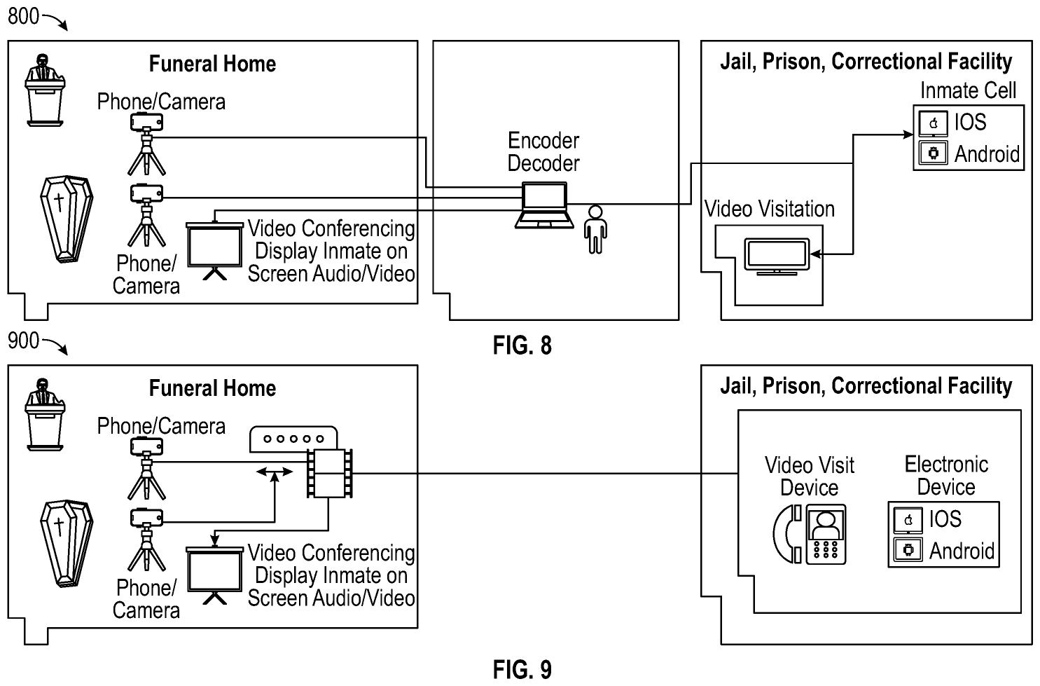

In FIG. 8, another example system 800 is depicted, in accordance with one or more example embodiments of the disclosure. The embodiment shown in FIG. 8 is similar to that shown in FIG. 1, and illustrates a system 800 utilizing an encoder 802 and decoder 804 to facilitate secure video transmission and communications between a location and a remote location.

In FIG. 9, another example system 900 is depicted, in accordance with one or more example embodiments of the disclosure. The embodiment shown in FIG. 9 is similar to that shown in FIG. 1, and illustrates a system 900 utilizing direct communications between a client device 902 at a location and a communication device 904 at a remote location.

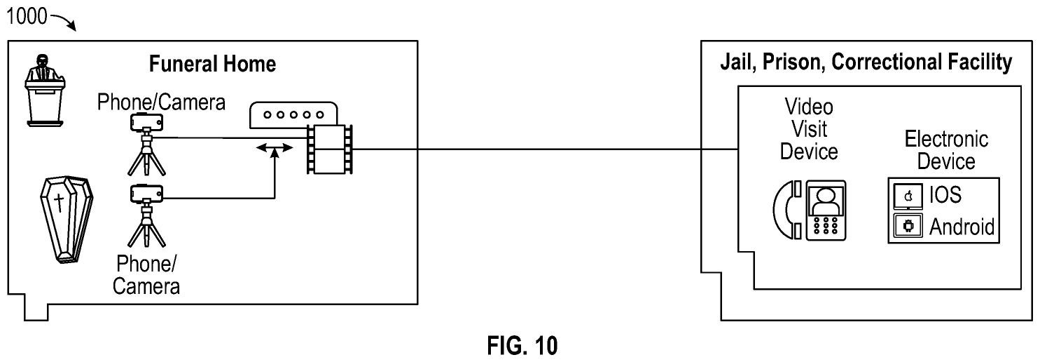

In FIG. 10, another example system 1000 is depicted, in accordance with one or more example embodiments of the disclosure. The embodiment shown in FIG. 10 is similar to that shown in FIGS. 1 and 9, and illustrates a system 900 utilizing direct communications between a client device 1002 at a location and a communication device 1004 at a remote location.

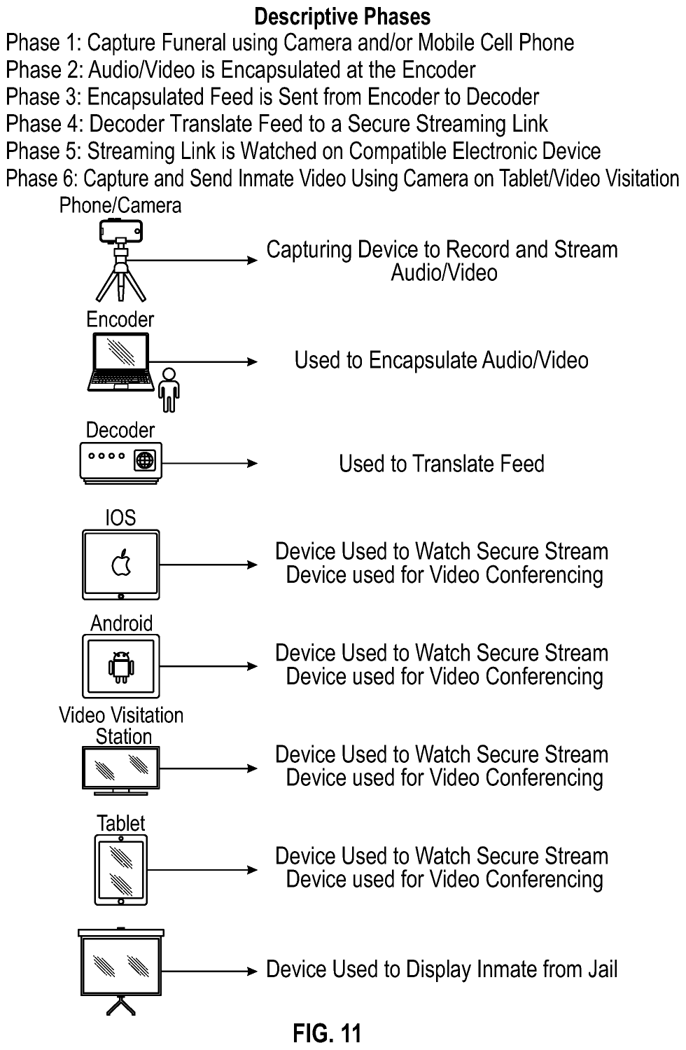

In FIG. 11, an example method is depicted, in accordance with one or more example embodiments of the disclosure. The method 1100 can include capturing video and audio using a camera and/or a mobile communication device with a camera. The method can also include encoding the video and audio using an encoder. The method can also include transmitting the encoded video and audio from the encoder to a decoder. The method can include decoding the encoded video and audio to send the decoded video and audio via a secure communication link to a remote location. The method can include facilitating end user access or viewing of the decoded video and audio at a communication device or media playing application or apparatus at the remote location. The method can include capturing video and audio of the end user, via the communication device, or media playing application or apparatus, for transmission back to the location for output at the location.

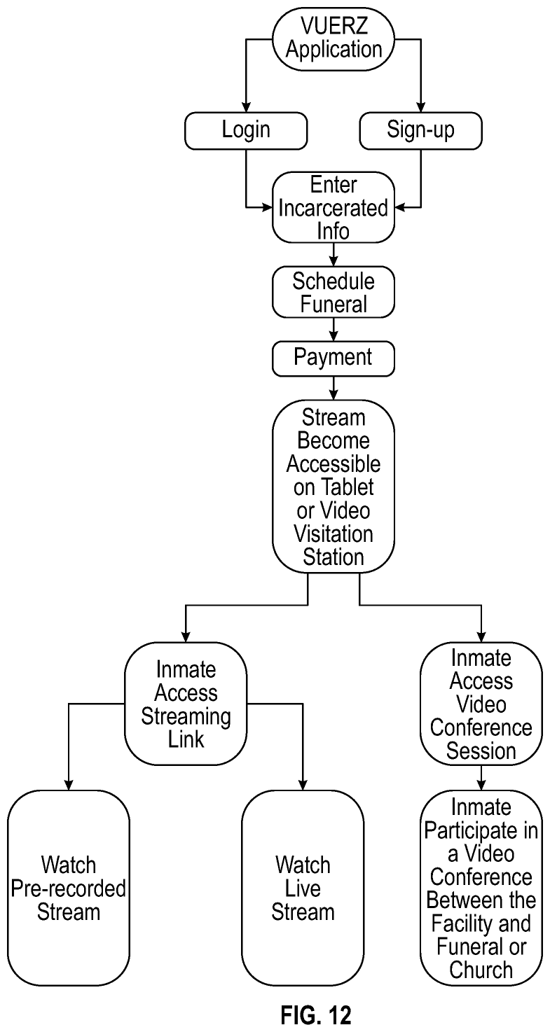

In FIG. 12, another example method is depicted, in accordance with one or more example embodiments of the disclosure. The method 1200 can include initiating an application program, or VUERZ application program. The method can include a login operation 1202 and a sign-up operation 1204. The method can include receiving end user information at operation 1206. The method can include scheduling end user access for a funeral service at operation 1208. The method can include receiving payment information at operation 1210. The method can include facilitating video and audio access for the end user via a communication device or media playing application or apparatus at operation 1212. In operation 1214, the method 1200 can continue by providing the end user with a secure communication link to access the video and audio. In operation 1216, the end user can access a pre-recorded stream of video and audio, whereas in operation 1218, the end user can access a live stream of video and audio. Returning to operation 1212, the method can continue at operation 1220, wherein the end user can access a video conference session. In operation 1222, the end user can participate in a video conference between the remote location and a location where the funeral service is being conducted.

The operations described and depicted in the illustrative process flow of FIGS. 11 and 12 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 11 and 12 may be performed.

One or more operations of the process flow of FIGS. 11 and 12 may have been described above as being performed by a user device, or more specifically, by one or more program modules, applications, or the like executing on a device. It should be appreciated, however, that any of the operations of process flow of FIGS. 11 and 12 may be performed, at least in part, in a distributed manner by one or more other devices, or more specifically, by one or more program modules, applications, or the like executing on such devices. In addition, it should be appreciated that processing performed in response to execution of computer-executable instructions provided as part of an application, program module, or the like may be interchangeably described herein as being performed by the application or the program module itself or by a device on which the application, program module, or the like is executing.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

In another embodiment, a machine or system can be provided in accordance with one or more example embodiments of the disclosure.

In other embodiments, the machine may operate as a standalone device or may be connected (e.g., networked) to other machines. In a networked deployment, the machine may operate in the capacity of a server machine, a client machine, or both in server-client network environments. In an example, the machine may act as a peer machine in peer-to-peer (P2P) (or other distributed) network environments. The machine may be a server (e.g., a real-time server), a computer, an automation controller, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific operation when in operation. The configuration may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) may include a hardware processor (e.g., a central processing unit (CPU), a graphics processing unit (GPU), a hardware processor core, or any combination thereof), a main memory and a static memory, some or all of which may communicate with each other via an interlink (e.g., bus). The machine may further include a power management device, a graphics display device, an input device (e.g., a keyboard), and a user interface (UI) navigation device (e.g., a mouse). In an example, the graphics display device, input device, and UI navigation device may be a touch screen display. The machine may additionally include a storage device (i.e., drive unit), a signal generation device (e.g., an emitter, a speaker), a fault detection device, a network interface device/transceiver coupled to antenna(s), and one or more sensors, such as a global positioning system (GPS) sensor, a compass, an accelerometer, or other sensor. The machine may include an output controller, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device may include a machine readable medium on which is stored one or more sets of data structures or instructions (e.g., software) embodying or utilized by any one or more of the techniques or functions described herein. The instructions may also reside, completely or at least partially, within the main memory, within the static memory, or within the hardware processor during execution thereof by the machine. In an example, one or any combination of the hardware processor, the main memory, the static memory, or the storage device may constitute machine-readable media.

The fault detection device may carry out or perform any of the operations and processes (e.g., the flow diagrams described with respect to FIGS. 11-12) described above.

While the machine-readable medium is illustrated as a single medium, the term “machine-readable medium” may include a single medium or multiple media (e.g., a centralized or distributed database, and/or associated caches and servers) configured to store the one or more instructions.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine and that cause the machine to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network. In an example, the network interface device/transceiver may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “monitoring and computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

It is understood that the above descriptions are for purposes of illustration and are not meant to be limiting.

Although specific embodiments of the disclosure have been described, numerous other modifications and embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or operations. Thus, such conditional language is not generally intended to imply that features, elements, and/or operations are in any way required for one or more embodiments.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database task or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

I claim:

1. A method comprising:
capturing, in real time, video images of a funeral service at a location;
transmitting, via at least one network, one or more of the video images to at least one RTMP (real time messaging protocol) server; and
facilitating end user access at a remote location comprising a correctional facility, via the at least one RTMP server, to the one or more video images, wherein the end user access comprises playback of the one or more video images on a media playing application or apparatus.

2. The method of claim 1, wherein the transmitting one or more video images is facilitated by a HLS (HTTP live streaming) protocol.

3. The method of claim 1, wherein the playback on a media playing application or apparatus further comprises playback of a downloaded file from the at least one RTMP server to the media playing application or apparatus.

4. The method of claim 3, wherein the downloaded file is stored locally on the media playing apparatus, wherein the one or more video images are stored in chunks or segments.

5. The method of claim 1, wherein the media playing application or apparatus is operable to facilitate playback of the one or more video images without network connectivity for the media playing application or apparatus during the playback.

6. The method of claim 1, further comprising:
synchronizing playback of the one or more video images with audio captured, in real time, at the funeral service at the location.

7. The method of claim 1, wherein the at least one RTMP (real time messaging protocol) server generates a unique and secure link via the at least one network for transmitting the one or more video images to at least one communication device associated with an end user at the remote location.

8. The method of claim 7, further comprising:
authenticating, based at least in part on receiving the unique and secure link from the location;
encoding the video images from the location; and
generating, via the at least one RTMP (real time messaging protocol) server, a destination URL (uniform resource locator) for facilitating end user access at the remote location, via the at least one RTMP server, to the one or more encoded video images.

9. The method of claim 1, further comprising:
prior to facilitating end user access at a remote location, evaluating the one or more video images by reviewing the one or more video images at the at least one RTMP (real time messaging protocol) server.

10. A system comprising:
a processor; and
a memory storing computer-executable instructions, that when executed by the processor, cause the processor to:
capture, in real time, video images of a funeral service at a location;
transmit, via at least one network, one or more of the video images to at least one RTMP (real time messaging protocol) server; and
facilitate end user access at a remote location comprising a correctional facility, via the at least one RTMP server, to the one or more video images, wherein the end user access comprises playback of the one or more video images on a media playing application or apparatus.

11. The system of claim 10, wherein the computer-executable instructions operable to transmit one or more video images are facilitated by a HLS (HTTP live streaming) protocol.

12. The system of claim 10, wherein the playback on a media playing application or apparatus further comprises playback of a downloaded file from the at least one RTMP server to the media playing application or apparatus.

13. The system of claim 12, wherein the downloaded file is stored locally on the media playing apparatus, wherein the one or more video images are stored in chunks or segments.

14. The system of claim 10, wherein the media playing application or apparatus is operable to facilitate playback of the one or more video images without network connectivity for the media playing application or apparatus during the playback.

15. The system of claim 10, wherein the computer-executable instructions, when executed by the processor, further cause the processor to:
synchronize playback of the one or more video images with audio captured, in real time, at the funeral service at the location.

16. The system of claim 10, wherein the at least one RTMP (real time messaging protocol) server generates a unique and secure link via the at least one network for transmitting the one or more video images to at least one communication device associated with an end user at the remote location.

17. The system of claim 10, further comprising computer-executable instructions, that when executed by the processor, cause the processor to:
authenticate, based at least in part on receiving the unique and secure link from the location;
encode the video images from the location; and
generate, via the at least one RTMP (real time messaging protocol) server, a destination URL (uniform resource locator) for facilitating end user access at the remote location, via the at least one RTMP server, to the one or more encoded video images.

18. The system of claim 10, further comprising computer-executable instructions, that when executed by the processor, cause the processor to:
prior to facilitating end user access at a remote location, evaluate the one or more video images by reviewing the one or more video images at the at least one RTMP (real time messaging protocol) server.

19. A non-transitory computer-readable medium storing computer-executable instructions, that when executed by a processor, cause the processor to perform operations of:
capturing, in real time, video images of a funeral service at a location;
authenticating, based at least in part on receiving the unique and secure link from the location;
encoding the video images from the location;
generating, via the at least one RTMP (real time messaging protocol) server, a destination URL (uniform resource locator) for facilitating end user access at the remote location, via the at least one RTMP server, to the one or more encoded video images;
transmitting, via at least one network, one or more of the video images to at least one RTMP (real time messaging protocol) server; and
facilitating end user access at a remote location comprising a correctional facility, via the at least one RTMP server, to the one or more video images, wherein the end user access comprises playback of the one or more video images on a media playing application or apparatus.

20. The non-transitory computer-readable medium of claim 19, further comprising computer-executable instructions, that when executed by the processor, cause the processor to:
prior to facilitating end user access at a remote location, evaluating the one or more video images by reviewing the one or more video images at the at least one RTMP (real time messaging protocol) server.
